(19) United States
(12) Patent Application Publication
(10) Pub. No.: US 2016/0364738 A1
(43) Pub. Date: Dec. 15, 2016

(54) PREDICTIVE TRACKING SYSTEM FOR USE DATA IN THE ANTIGEN SUPPLY CHAIN TO DEFINE MANUFACTURING REQUIRED LEVELS

(71) Applicant: ROCA MEDICAL LTD., LONDON (GB)

(72) Inventors: JAMES STRADER, AUSTIN, TX (US); JOVAN HUTTON PULITZER, FRISCO, TX (US)

(21) Appl. No.: 15/183,715

(22) Filed: Jun. 15, 2016

Related U.S. Application Data
(60) Provisional application No. 62/175,998, filed on Jun. 15, 2015.

(51) Int. Cl. G06Q 30/02; G06N 99/00

(52) U.S. Cl. CPC G06Q 30/0202; G06N 99/005

(57) ABSTRACT

A method for predicting demand for allergens for a given calendar time span utilizes a non-linear network having a set of inputs corresponding to inputs associated with economic and demand data with respect to use of allergens over a first defined time span of the calendar year from a first predetermined calendar day to a second predetermined calendar day. A predictive output is provided for yielding a prediction of economic and demand data over a second defined time span of the calendar year. The second defined time span of the calendar year is later than the first defined time span of the calendar year. The input actual data is through the trained representation to provide a prediction on the output thereof of the nonlinear network of the economic and demand data for the second defined time span of the calendar year.

### CROSS-REFERENCE TO RELATED APPLICATIONS

This application claims the benefit of U.S. Provisional Application No. 62/175,998, filed on Jun. 15, 2015, entitled PREDICTIVE TRACKING SYSTEM FOR USE DATA IN THE ANTIGEN SUPPLY CHAIN TO DEFINE MANUFACTURING REQUIRED LEVELS, which is incorporated by reference herein in its entirety.

### TECHNICAL FIELD

The following disclosure relates to supply chain systems and the ability to control the manufacturing output level in accordance with data from collected statistics over a given time utilizing a predictive engine.

### BACKGROUND

Antigens are manufactured based upon anticipated demand levels. However, demand levels are a function of multiple factors, which are difficult to anticipate by a given manufacturer. In some situations, rainfall in a certain period of the year can result in a high level of certain pollens in the air eight months in the future. Compared to a prior year, this rainfall did not exist and the level of pollens at a particular time may not have been affected by the lower amount of rainfall in a prior month. The demand for allergens in a low rainfall year may have been relatively low whereas, in a year preceded by high rainfalls, the demand for later allergens may have increased. Further, it is possible that the quality of the harvest based upon rainfall or other environmental factors could have changed and the effectiveness of allergens could have been reduced. This may have increased the demand for the allergens.

There are many databases that currently exist that are not integrated into a single decision based entity for determining demand. The pharmacist, for example, generates quests or orders for allergens based upon prescriptions received. However, the pharmacist database is not maintained for the level of integrating or sharing with other entities, as all the pharmacists are concerned with are the cost of the allergen, the availability of the allergen and the safety of the allergen. Whether the demand is high or low in any period of time is not a concern to the pharmacist, but the data as to the demand is still present. There are also many databases that track environmental data that has some relationship to antigen quality, antigen production, etc.

For example, manufacturers of antigens for such things as oak pollen have a fairly good knowledge that certain environmental factors can affect the harvest for that oak pollen. However, the issue is whether a manufacturer will recognize that certain things may occur that could impact demand for oak pollen, for example, in the future. Since many of these allergens have a finite shelf life, a manufacturer is seldom desirous of overharvesting something such as oak pollen if there is no real demand for it. The harvesting and processing of such pollen can be reasonably expensive for something that may just sit on the shelf. It typically has a finite amount of time or a small window within which it will be used in the high peak season and this is what manufacturers want to plan for. Currently, no system exists for integrating the databases together from multiple parties or multiple systems that have information that can be related to demand for any particular antigen, i.e., the demand is a function of these factors. However, this function is a relatively unknown function. Currently it is somewhat of a rule of thumb type estimation.

### SUMMARY OF THE INVENTION

The present invention disclosed and claimed herein comprises a method for predicting demand for allergens for a given calendar time span based on training data, wherein the given calendar time span is in the future relative to currently available data. Initially, a non-linear network is provided having a set of inputs corresponding to inputs associated with economic and demand data with respect to use of allergens over a first defined time span of the calendar year from a first predetermined calendar day to a second predetermined calendar day. A predictive output is provided for yielding a prediction of economic and demand data over a second defined time span of the calendar year from a first predetermined calendar day to a second predetermined calendar day. The second defined time span of the calendar year is later than the first defined time span of the calendar year, the non-linear network having a trained representation of the relationship between the input and the predicted output stored therein. The non-linear network is trained on a set of historical input data defining historical input data existing between the first predetermined calendar day and the second predetermined calendar day of the first defined time span of the calendar year for previous years having associated there with actual training data for the second defined time span of the calendar year and were in the training operation trains these set of historical input data against the associated target data associated with the second defined time span of the calendar year. Each set of historical data for each first defined time span of the calendar year has associated there with a corresponding set of target data for the second defined time span of the calendar year, the training operation and generating the trained representation of the relationship between the input and he predicted output of the nonlinear network. Actual data is measured over a time span from a first calendar day to a second calendar day corresponding to the first calendar day and the second calendar day of the first defined time span of the calendar year. The input actual data is through the trained representation to provide a prediction on the output thereof of the nonlinear network of the economic and demand data for the second defined time span of the calendar year.

### BRIEF DESCRIPTION OF THE DRAWINGS

For a more complete understanding, reference is now made to the following description taken in conjunction with the accompanying Drawings in which:

FIG. 1 illustrates a general diagram of the diversity of databases that could provide information to a central collection area;

FIGS. 2A-D illustrate a plurality of diagrams of the presence of data that can be collected or that has been collected over time relating to various factors.

FIG. 3 illustrates general diagram of a predictive engine such as a neural network;

FIG. 4 illustrates a general diagram of a three layer neural network;

FIG. 4A illustrates a simplified view of the three layer neural network;

FIG. 5 illustrates simplified block diagram of the neural network;

FIG. 6 illustrates a plot of data that may affect the demand in the month of August;

FIG. 7 illustrates an overall input diagram of multiple input vectors to a neural network for a single month demand;

FIG. 8 illustrates a diagrammatic view of a prediction in one month based upon data collected in prior months; and

FIG. 9 illustrates a flow chart for the overall data collection operation.

### DETAILED DESCRIPTION

Referring now to the drawings, wherein like reference numbers are used herein to designate like elements throughout, the various views and embodiments of a method for predicting demand for allergens in the marketplace in order to refine the manufacturing supply side of the allergen business are illustrated and described, and other possible embodiments are described. The figures are not necessarily drawn to scale, and in some instances the drawings have been exaggerated and/or simplified in places for illustrative purposes only. One of ordinary skill in the art will appreciate the many possible applications and variations based on the following examples of possible embodiments.

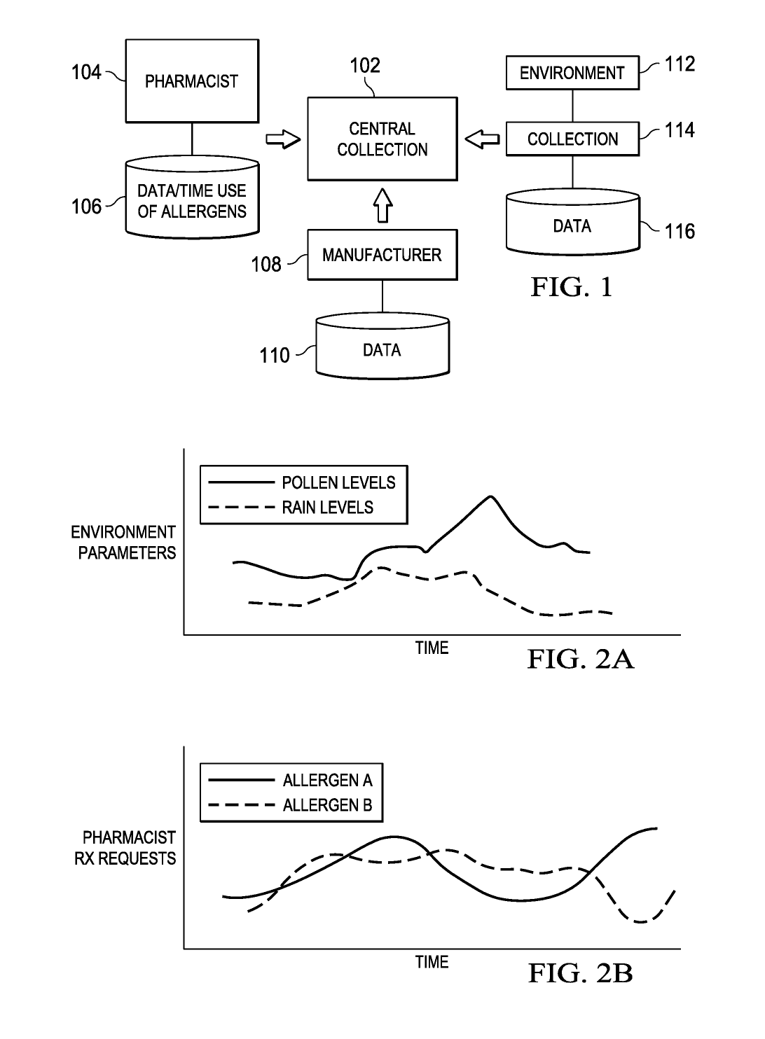

Referring now to FIG. 1, there is illustrated a diagrammatic view of a plurality of disparate databases for collecting information and transferring information to a central collection area 102. One data collection area is that associated with a pharmacist operation 104. This is generally the database of all pharmacist operations which are collected in a database 106, which basically relates to data collected over time relating to information regarding prescriptions received, prescriptions filled, allergens ordered, all associated with the delivery of allergens. A pharmacist may order the allergens for the purpose of stockpiling the allergen, for the purpose of filling a prescription at the request of a medical professional such as an allergist, or even directly delivering the allergen to a patient by a prescription. Thus, this particular aspect of the database relates to the actual point in the distribution chain to which a manufacturer directly ships their product. This database 106 represents information as to what type of demand a manufacturer might see. Even though a pharmacist might order allergens based on some perceived need, it is still a demand that must be met by the manufacturer. If, for some reason, a pharmacist or a requester of such product is concerned that there might be an outbreak of some allergy in the future, they might order a large amount of allergen. If the manufacturer cannot predict this, the manufacturer may miss out on an opportunity for sales. On the other hand, the manufacturer might stockpile too much base concentrate material for a given allergen based upon the actual demand.

Another source of information is basically the actual manufacturer delivery and trend for stockpiling and delivery of base concentrate allergen material. If taken over a large number of manufacturers at some central collection point such as the manufacturer 108 with the database 110, this provides valuable data to a central collection unit 102.

A further source of information regarding demand for allergen is that associated with the environment 112. The environment can affect the actual supply of allergens, such as various pollens and it also can affect the demand of pollen related, or environmental related, allergies, such as pollen allergies, etc. For example, one year might be a very dry year with rain occurring at certain times in the growing season of particular trees and another year might be a very wet year at that time. Six months in the future, there may be a higher demand for a particular allergen as a result of this environmental factor. As such, environmental data may be collected at a point 114 and disposed in a database 116.

Demand is a function of many factors. Therefore, there may be a single value for demand that can be defined as a vector of one value of demand associated with, for example, a single month out of the year. This would provide a single vector of information y(t) with the input information being various things as manufacturer applied times, manufacturer delays, environmental aspects and even demand in other months. These form an input vector of information x(t). Thus, based upon a large amount of information, there is some function wherein y(t)=f(x(t)). This particular function must somehow be defined. One way to define this is to determine an algorithm or the such which would provide a first principals model of the overall supply chain process as a function of the input vector. If one could define this as a linear process, this would be advantageous. However, there are so many variables, that this becomes a nonlinear system. Nonlinear systems are typically well modeled by nonlinear modeling systems, such as neural networks. Neural networks are a type of nonlinear model which stores weighting factors in relationship to many factors between the various input values or input data and an output predicted value and trains these weights on a data set to a backpropagation training algorithm. These neural networks are well known.

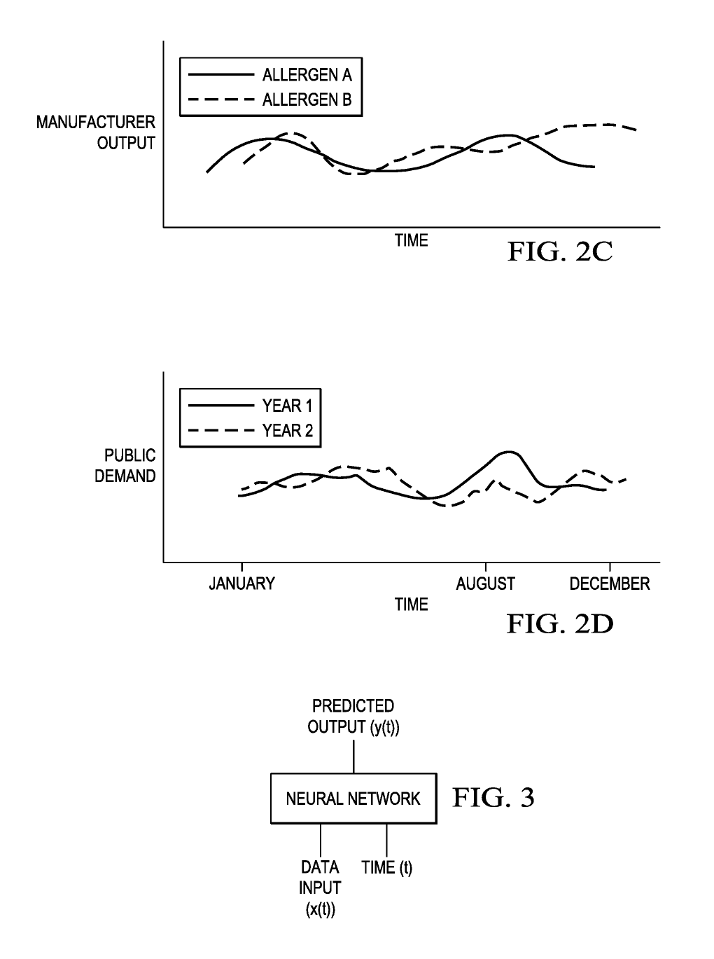

Referring now to FIGS. 2A-D, there are illustrated various diagrams of how data changes over time. In FIG. 2A, there is illustrated a time diagram of various environmental parameters as a function of time of months or even years. There are two environmental parameters illustrated, one being pollen levels and one being rain levels in a particular area, for example. In FIG. 2B, there is illustrated a graph of pharmaceutical requests at a pharmacy for prescriptions over time, representing actual demand at a point of distribution. There are illustrated two curves, one for a first allergen and one for a second allergen. In FIG. 2C, there is illustrated a graph for manufacturer output over time for a first allergen and a second allergen. In FIG. 2D, there is illustrated a graph for the basic overall public demand over time, illustrating one graph for the first year and a second graph for a second year. Although these are just samples of the kind of data that might be useful, there are many factors that can actually control demand. With a nonlinear system, such as a neural network modeling system, it is difficult to determine which parameter has an effect on the overall demand for a given month. However, with a neural network modeling system, even if this input were provided as a single input, the single input, through training, would be determined by the neural network to be relatively insignificant or have little influence on the demand and, as such, the weight attributed to that would be minimal. This, of course, would be the result of training. In any event, a large number of factors to affect the demand and the more of these factors that can be included in the training of the network, the better the prediction.

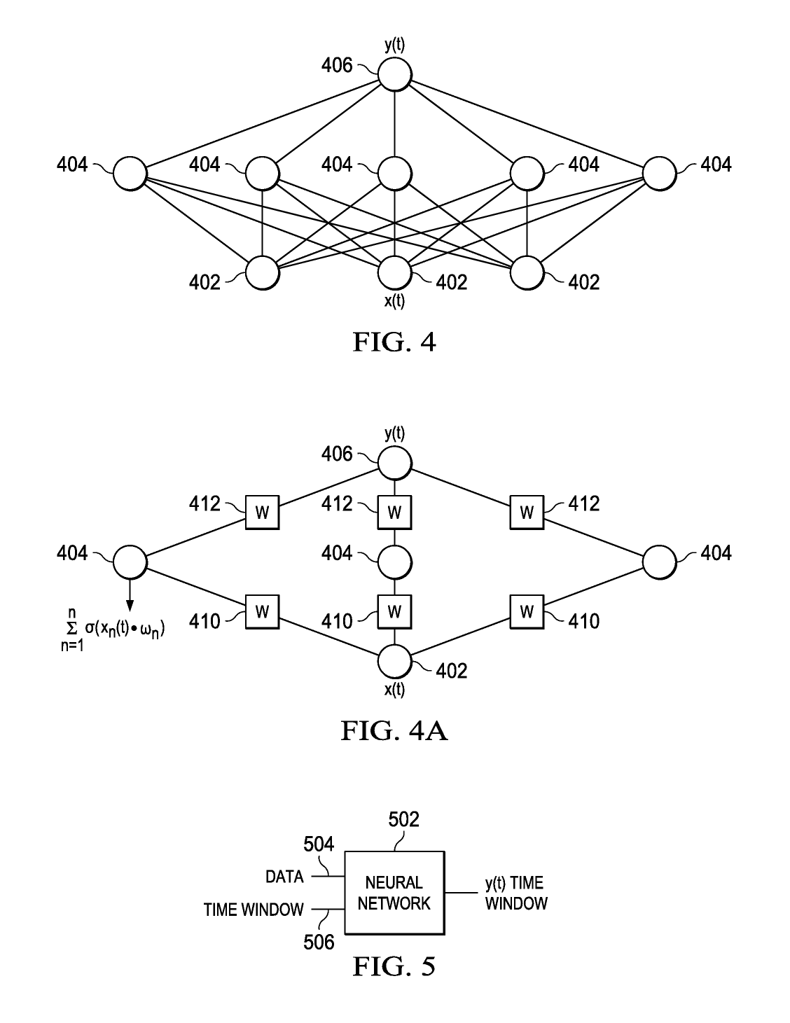

Referring now to FIG. 3, there is illustrated a base diagram of a neural network. This neural network provides as an output the vector y(t) and as an input two inputs, the large amount of data in the vector x(t) and a time input, such as which month the model is associated with. The overall diagram of the neural network is illustrated FIG. 4. In this figure, there are provided three layers, a first input layer 402 comprised of three nodes 402. They would be provided one node for each input values such that, if the vector x(t) was comprised of the values of x₁, x₂, x₃, . . . , xₙ, each value associated with the vector input would occupy a single node 402 as a separate and distinct input. Each of these nodes 402 is related to one of multiple nodes in a hidden layer, comprised of nodes 404. There can be any number of these nodes, depending upon the design of the overall network. However, each of the input nodes 402 would be interfaced with each of the nodes 404 through a weighted relationship. Nodes 404 sum all of the weighted inputs and process them through some type of sigmoid function, for example. When the weighted sum exceeds a certain value as defined by the sigmoid function, this will fire that node to generate an output. Each of nodes 404 is input through a weighted value to an output layer which, in this example, is comprised of a single node 406 for the output factor y(t). Thus, the output node 406 will sum the weighted values of each of the nodes 404 to provide a single output value.

Referring now to FIG. 4A, there is illustrated a signified diagrammatic view of one input node 402 processed through three hidden nodes 404. There will be weighting factors associated with each link between node 402 and node 404. This is defined as a weight 410. This is a trained value. Similarly, each node 404 is linked to the output node 406 through a weighted value 412. It should be understood that each weighted value between any two nodes is associated with that node and is independent in value of the other weights. The equation for each of the hidden nodes is illustrated as being in the sum of weighted input values multiplied by the sigmoid function.

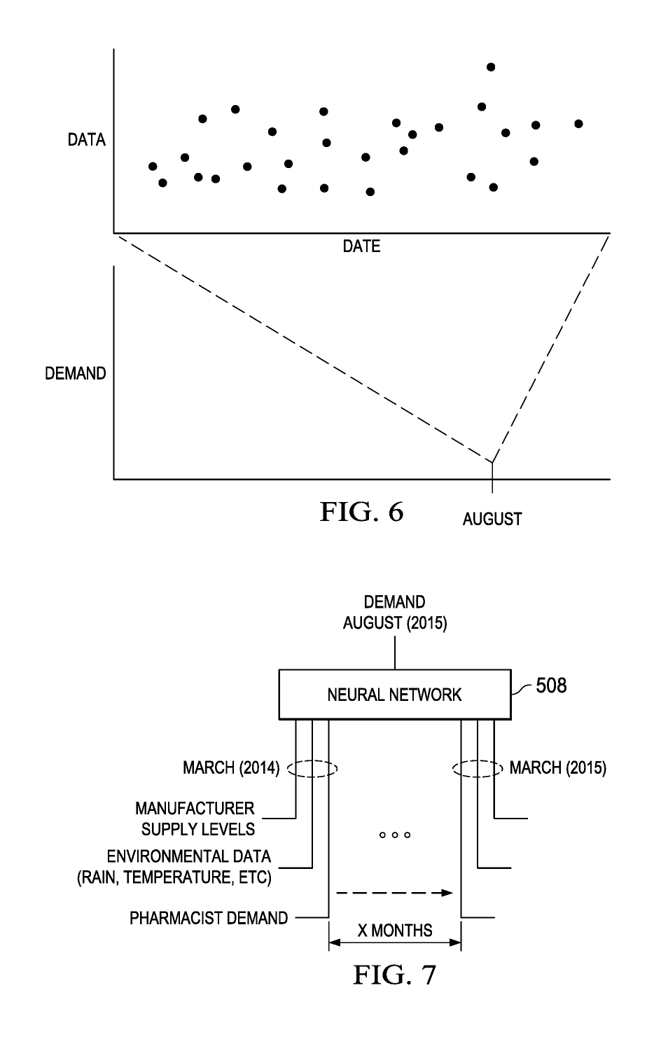

Referring now to FIG. 5, there is illustrated a simple block diagram of a neural network 502 that receives data from a database on an input 504 and some type of indication as to the desired time window on input 506. Each neural network, after training, has the weights defined and this provides a stored representation or model of the relationship between the output vector and the input vector. Thereafter, a new set of input data can be input to the neural network and a prediction made as to the closest approximation to an output that would predictably result from the data based upon the model which was trained upon historical data. In FIG. 6, there is illustrated a typical operation wherein a demand would be input to the network in, for example, a defined time period. If the demand were desired, for example, in the month of August, the demand for each day in August could be provided as a vector output and the input could be the set of data for a given year. The network could be trained on the demand for each day of the month of August over multiple years of data. For example, suppose that there were accrued 10 years' worth of data and 10 years' worth of demand for the month of August. This could be the demand based upon the average over a week in August, the average over the month of August or the daily value during August. Each one of these would represent a given vector input.

Suppose, for example, that the demand would be desired to be modeled for just the average over the entire month of August based on the various input data that would be collected over a year, from March of the year before to March of the current year. Thus, the demand would be generated for the month of August for each year and input to the network in a training algorithm and then the data for the entire prior term year from the month of March to the month of March and input to the input layer of the network. Once trained, all that would be required would be to provide as an input current data for the prior term year from the month of March to the month of March. This would provide a manufacturer with information regarding the demand for August in the month of March. By taking all of the data one year spanning the prior year in March to the current year in March, and in putting this to the model, this would provide a prediction for the average demand in August.

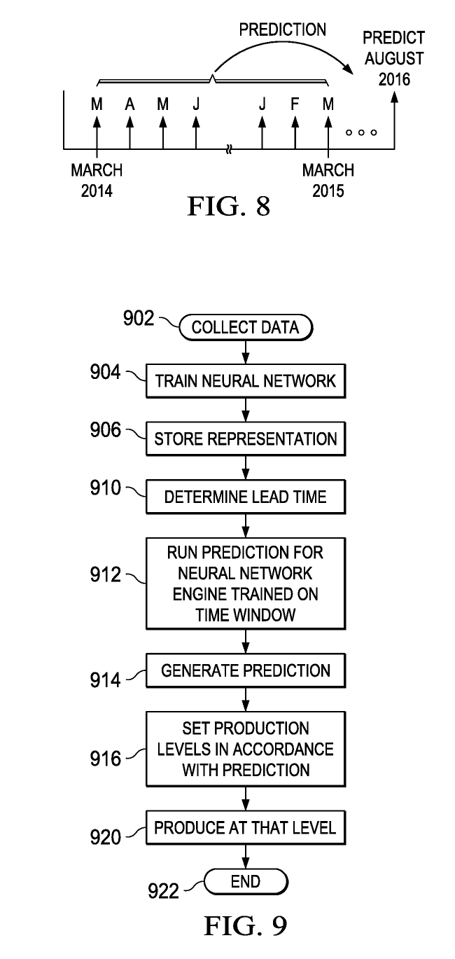

As illustrated in FIG. 7, the data inputs are provided for each month relating to manufacturer supply levels, environmental data for a given month, demand for given month at pharmacists, etc. This would provide a large number of inputs. Of course, it may be that the only environmental data that was considered relevant was rain. For each month this data would be collected over a number of years and then input to the data in a training algorithm. Once trained, the weights are fixed and then the system can be run. All that is required to run the data is to provide current data over the same period for which the neural network was trained. If, for example, in March 2015, a manufacturer wanted to know the demand for August 2015, all that would be required would be to input the data for the period between March 2014 and March 2015. If, alternatively, manufacturer wanted the data for June 2015, a different model would have to be trained. However, they never could actually be trained such that the given parameters of the input set of data, i.e., between March 2014 to March 2015, so that there could be provided a vector output for the average demand in April, May, June, July, August, etc. This is illustrated in the diagram of FIG. 8.

Referring now to FIG. 9, there is illustrated a flowchart depicting the overall operation of the predictive system. The first step is initiated at a block 902 wherein data is collected. The process then flows to block 904 wherein the neural network is trained on historical data that is functionally related to the desired predicted output, such as demand for a given month. The program then flows to a function block 906 to store a representation of the model based on the information. The program then flows to a function block 910 in order to determine the lead time that is desired. If, for example, the lead time is four months, then a given set of data must be trained with respect to the network over a given length of time for a given amount of data over a number of historical periods to train the model. In the above example, the lead time was five months. The program then flows to a function block 912 to run a prediction for the neural network engine that was trained on a basic time window, i.e., for data between March of one year to March of the next year. The process then flows to a function block 914 to generate the prediction, this facilitated by placing another set of data, i.e., termed “current” data, to the input layer of the network. The process then flows to a block 916 to basically set production levels in accordance with the predicted value. If, for example, based upon all of the information over that given period, i.e., from March of one year to March of another year, demand in the month of August was predicted to be quite high, production could be increased or, alternately, for a low prediction of demand, the production decreased. The lead time of five months may not be the right value whereas lead time may be shorter. For some situations, such as pollen production, the harvesting may be closer to the actual allergy season. Thus, defining base input information or ranges that will be useful for training the network and then taking large amounts of historical data for those ranges over a number of years and then training the network for outputs extending from one month to two months to three months, etc., after the end of the period, a valuable tool can be provided for the manufacturer. Once a prediction is made in the production level set, the manufacturer executes upon the prediction and produces at that level, as indicated by block 920. The program then proceeds to block 922.

Although the preferred embodiment has been described in detail, it should be understood that various changes, substitutions and alterations can be made therein without departing from the spirit and scope of the invention as defined by the appended claims.

What is claimed is:

1. A method for predicting demand for allergens for a given calendar time span based on training data, wherein the given calendar time span is in the future relative to currently available data, comprising the steps of:
providing a non-linear network having a set of inputs corresponding to inputs associated with economic and demand data with respect to use of allergens over a first defined time span of the calendar year from a first predetermined calendar day to a second predetermined calendar day and an predictive output providing a prediction of economic and demand data over a second defined time span of the calendar year from a first predetermined calendar day to a second predetermined calendar day, which second defined time span of the calendar year is later than the first defined time span of the calendar year, the non-linear network having a trained representation of the relationship between the input and the predicted output stored therein;
training the non-linear network on a set of historical input data defining historical input data existing between the first predetermined calendar day and the second predetermined calendar day of the first defined time span of the calendar year for previous years having associated there with actual training data for the second defined time span of the calendar year and were in the training operation trains these set of historical input data against the associated target data associated with the second defined time span of the calendar year, wherein each set of historical data for each first defined time span of the calendar year has associated there with a corresponding set of target data for the second defined time span of the calendar year, the training operation and generating the trained representation of the relationship between the input and he predicted output of the nonlinear network;
inputting actual data measured over a time span from a first calendar day to a second calendar they corresponding to the first calendar day and the second calendar day of the first defined time span of the calendar year;
processing the input actual data through the trained representation to provide a prediction on the output thereof of the nonlinear network of the economic and demand data for the second defined time span of the calendar year.

2. The method of claim 1, where in the nonlinear network comprises a neural network.

3. The method of claim 1, where in the first defined time span of the calendar year comprises a full year.

4. The method of claim 1, wherein the second defined time span of the calendar year comprises a single day.

5. The method of claim 1, wherein the second defined time span of the calendar year comprises a month.

6. The method of claim 1, wherein the economic and demand data comprises manufacturer supply levels, environmental data and pharmacist demand.

7. The method of claim 1, wherein the economic and demand data includes at least demand data determined by a pharmacist distribution of allergens during the first defined time span of the calendar year.

8. The method of claim 7, wherein the economic and demand data includes environmental data at least.

9. The method of claim 8, wherein the output data comprises predicted demand data.

10. The method of claim 8, wherein the output of the neural net or comprises a prediction of the average demand for a month, the month comprising the second defined time span of the calendar year.
